(19) United States
(12) Patent Application Publication
(10) Pub. No.: US 2018/0090034 A1
(43) Pub. Date: Mar. 29, 2018

(54) INSTRUCTION MANUAL

(71) Applicant: Casio Computer Co., Ltd., Tokyo (JP)

(72) Inventor: Marie Hashimoto, Tokyo (JP)

(21) Appl. No.: 15/660,088

(22) Filed: Jul. 26, 2017

(30) Foreign Application Priority Data
Sep. 27, 2016 (JP) 2016-188678

(51) Int. Cl. G09B 25/02; G09B 19/00

(52) U.S. Cl. CPC G09B 25/02; B42D 9/06; G09B 19/00

(57) ABSTRACT

An instruction manual is constituted by pages composed of different types of paper, such as plain paper, thin paper and thick paper. Each of the plain paper, the thin paper, and the thick paper constitutes a plurality of pages. The instruction manual describes that, for example, “the paper of page 1 to page 10 corresponds to plain paper, the paper of page 11 to page 21 corresponds to thin paper, and the paper of page 22 and subsequent pages corresponds to thick paper”, and describes that “pages that are thicker than the thick paper of page 22 and subsequent pages may not be properly turned”. The user views and touches pages composed of these different types of paper to recognize the differences among plain paper, thin paper, and thick paper, and thereby more correctly understands the contents contained in the instruction manual.

### CROSS-REFERENCE TO RELATED APPLICATION

This application is based upon and claims the benefit of priority from the prior Japanese Patent Application No. 2016-188678, filed Sep. 27, 2016, the entire contents of which are incorporated herein by reference.

### BACKGROUND OF THE INVENTION

### 1. Field of the Invention

The present invention relates to an instruction manual.

### 2. Description of the Related Art

Conventionally, as an apparatus which automatically turns pages of a book or the like, a page turner is known which turns overlapping pages one by one by sticking thereto (for example, refer to Japanese Patent Application Laid-Open (Kokai) Publication No. 06-048067).

However, if any malfunction occurs in this page turner, the cause is difficult to identify and therefore more suitable use conditions are difficult to set. For example, in a case where the page turner does not properly turn pages, the cause may be related to the life-span of members for holding and releasing pages of the book, the paper type of the pages, settings for each unit, or the like. However, it is difficult for the user to judge whether the cause of this malfunction is the life-span of the members for holding and releasing pages of the book, the paper type of the pages, or the settings for each unit.

Also, for example, a technique is known in which various paper samples are provided in the form of a brochure or the like by use of a bookbinding technique (for example, refer to Japanese Patent Application Laid-Open (Kokai) Publication No. 2012-232468). Here, as the paper samples, various types of paper including thick paper and hard paper are bound. With this brochure, the user can check paper types (different colors, thicknesses (weights), materials, and the like). However, this is merely a technique where the paper type of pages constituting a book on a page turner is presented.

### SUMMARY OF THE INVENTION

In accordance with one aspect of the present invention, there is provided an instruction manual for an apparatus which turns pages of an opened book, comprising: a plurality of indices for setting operation conditions for the apparatus as a page structure of the instruction manual.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

The present invention can be more clearly understood by the detailed description below being considered together with the following drawings.

FIG. 1 is a perspective view showing a schematic structure of a page turner 1 in an embodiment;

FIG. 2 is a schematic view showing an example of an instruction manual that is provided together with the page turner 1 in the embodiment;

FIG. 3 is a schematic view showing another example of the instruction manual that is provided together with the page turner 1 in the embodiment; and

FIG. 4 is a conceptual diagram showing a list of indices that is given by the instruction manual provided together with the page turner 1 in the embodiment.

### DETAILED DESCRIPTION OF THE PREFERRED EMBODIMENT

A preferred embodiment of the present invention will hereinafter be described with reference to the accompanying drawings. Note that, although the embodiment described below is provided with various technically preferable limitations in order to carry out the present invention, these limitations are not intended to limit the scope of the present invention to the embodiment and examples shown in the drawings.

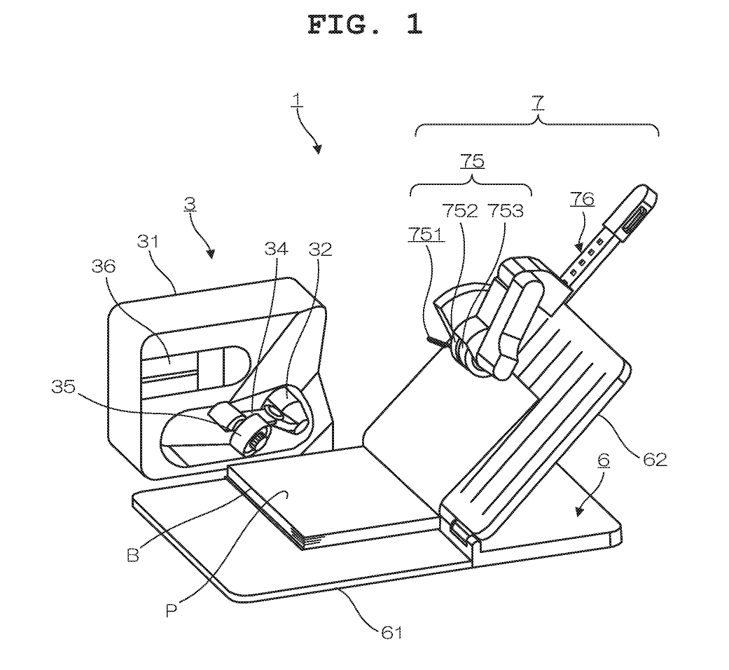

FIG. 1 is a perspective view showing a schematic structure of a page turner 1 in the embodiment. Note that in the following descriptions a case is exemplarily described in which pages P of a book B are turned from left to right.

This page turner 1 includes a page-turning section 3 which turns pages P of the book B, a holding table 6 on which the book B is set, and a page holding section 7 which holds pages P at a page-turning end point, as shown in FIG. 1. Note that, although omitted in the drawing, this page turner 1 also includes a stand section on which an information processing terminal (such as a smartphone or a tablet) having imaging means for photographing pages P of the book B is set.

The page-turning section 3 includes an accommodation case 31 having a substantially rectangular parallelepiped shape, a driving shaft 32 which is driven to be rotated by driving means such as a motor, an arm section 34 which swings around the driving shaft 32, a sticking section 35 which is attached to a distal end of the arm section 34 and sticks to a page P of the book B, an air blowing section 36 which blows air against a page P at a page-turning end point by making air pass above a page P at a page-turning start point, and a control section not shown which controls the respective sections.

The accommodation case 31 accommodates the driving shaft 32, the arm section 34, the sticking section 35, and the air blowing section 36. The holding table 6 includes a pair of holding plates 61 and 62 which is foldable by a hinge not shown. In the case of the present embodiment in which pages P of the book B are turned from left to right, one holding plate 61 of the pair of holding plates 61 and 62 which is located on the left side is placed along the surface of a table, and the other holding plate 62 located on the right side is placed obliquely upward on the table at a predetermined tilt angle with respect to the holding plate 61. On the holding plate 61, Pages P that serve as page-turning start points of the book B are placed. On the other holding plate 62, pages P that serve as page-turning end points of the book B are placed.

Accordingly, the holding table 6 holds the book B such that the pages P on the page-turning end side tilt in a direction to rise with a seam b2 of the book B as an axis, as compared to the pages P on the page-turning start side. Note that, since the pair of holding plates 61 and 62 is foldable by the hinge, an angle between the pair of holding plates 61 and 62 can be adjusted and a tilt angle of a page P at a page-turning end point with respect to the horizontal plane can be freely adjusted. This tilt angle should preferably be adjusted in the range of 30° to 45°.

The page holding section 7 includes a page holder 75 and a positioning section 76. The page holder 75 includes a catching section 751, a pull-in roller 752, and a pressing roller 753. The catching section 751 catches and brings each page P to a page-turning end point so as to prevent it from returning to a page-turning start point. The pull-in roller 752 rotates coaxially with the catching section 751 and pulls in each page P conveyed by the sticking section 35 and caught by the catching section 751 so as to prevent it from returning to a page-turning start point. The pressing roller 753 presses and holds each page P at a page-turning end point.

The positioning section 76 adjusts the fixing position of the page holder 7 on the holding plate 62 in accordance with the size of the book B such that the roller surfaces of the pull-in roller 752 and the pressing roller 753 are placed on an edge portion of a page P turned and positioned at a page-turning end point, and fixes the page holder 7 on the holding plate 62.

In the above-described structure, when the driving shaft 32 is rotated, the arm section 34 reciprocates between a page-turning start point of pages P and a page-turning endpoint thereof as if it draws an arc centered on the driving shaft 32. In the following descriptions, a movement from a page-turning start point of pages P to a page-turning end point thereof is regarded as a forward movement, and a movement from a page-turning end point to a page-turning start point is regarded as a backward movement.

When the arm section 34 is moved forward by a page-turning operation, a page P at a page-turning start point which has been stuck to the sticking section 35 moves toward a page-turning end point along with this forward movement of the arm section 34.

Subsequently, when the page P stuck to the sticking section 35 approaches the page-turning end point by being conveyed, the page holder 75 catches this page P by the rotational movements of the vane sections of the catching section 751.

Then, the page holder 75 pulls in the caught page P by the pull-in roller 752, and presses it by the pressing roller 753 so as to hold it at the page-turning end point.

In the backward movement of the arm section 34, its travelling direction is reverse to the direction of the forward movement. Here, the sticking section 35 moves along the same path while being separated from the page P, and then sticks to a new page P at a page-turning start point. By this reciprocating operation being repeated, the operation of turning pages P is continued.

In the use of the above-described page turner 1, the classification of the book B is important. However, classifying the book is not easy unless the user is a person who often works with books or paper in daily life. For example, in a case where “soft paper such as that used for magazines” and “plain paper such as that used for paperback books” have been presented in an instruction manual for the page turner 1 as selectable paper types for the pages P, whether the pages P of the book B in hand correspond to “soft”, “plain”, or “hard” is not clear because it depends on the user's individual feeling.

This also applies to the book size. Some person who is not usually conscious of paper sizes such as A4 and B4 may find difficulty in judging whether the book B in hand “has a size larger than A5 size or has a size smaller than A5 size”.

In a case where an adhesive tape is used for the sticking section 35 which sticks to a page P, the adhesive force of the adhesive tape decreases with the duration of use (the number of the pages). When the adhesive force of the adhesive tape decreases, the sticking section 35 does not properly stick to a page P and therefore does not turn the page P. Accordingly, the outmost circumferential portion of this adhesive tape in a roll shape needs to be peeled away to expose a new surface or the adhesive tape itself needs to be replaced as needed.

Here, the adhesion and life-span of the adhesive tape greatly vary depending on the paper type, paper quality, and the like of the pages P. For example, glossy paper such as that used for photo collections easily sticks to the adhesive tape and its paper fibers and ink thereon do not easily adhere to the adhesive tape. The use of such paper will slow down the deterioration of the adhesive tape. In contrast to this, recycled paper such as that used for weekly comic magazines easily comes unstuck and its paper fibers and ink thereon easily adhere to the adhesive tape. The use of such paper will speed up the deterioration of the adhesive tape.

That is, even when the instruction manual describes that “it is usable for about XXX sheets of plain paper”, the life-span of the adhesive tape is hard to judge because it depends on the paper types and paper qualities of books for which the adhesive tape has been used. Also, when a page P cannot be properly turned, it may be due to an improper classification of the book or to settings for each unit of the product, other than the life-span of the adhesive tape. For example, even when the user assumes that “pages cannot be properly turned due to the life-span of the adhesive tape” and use a new tape surface, the pages may not be properly turned if the settings are not proper. In such a case, the user wastes the adhesive tape that can still be used.

Also, when making an inquiry to a call center therefor, the user may find difficulty in sharing information about the type of the book in use only by conversation, which may impose a burden on both the user and the operator. For example, when the operator asks, “Is the size of the book in hand larger than B5?”, the user may think, “What size is B5?”.

In order to solve this problem, the present embodiment has a feature by which the book type instruction manual to be provided with the page turner 1 functions as “indices” or serves as “a reference book” which provides judgment criteria with respect to items required to be judged by the user in the use of the page turner 1, such as the book size, the paper type of the pages, and the life-span of the adhesive tape.

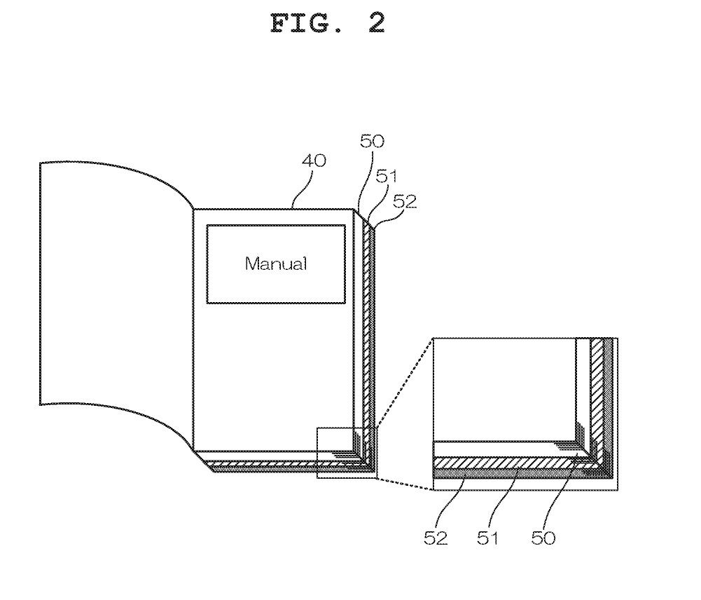

FIG. 2 is a schematic view showing an example of this instruction manual 40 which is provided with the page turner 1 in the embodiment. This instruction manual 40 is constituted by pages using different types of paper. In the case shown in FIG. 2, the instruction manual 40 is constituted by at least three types of paper, namely plain paper 50, thin paper 51, and thick paper 52. The plain paper 50, the thin paper 51, and the thick paper 52 each constitute a plurality of pages. In this case, the instruction manual 40 provides explanations such as “Paper of page 1 to page 10 corresponds to plain paper. Paper of page 11 to page 21 corresponds to thin paper. Paper of page 22 and the subsequent pages corresponds to thick paper. Pages using paper thicker than the thick paper of page 22 and the subsequent pages may not be properly turned”.

The user can recognize the differences among the plain paper 50, the thin paper 51, and the thick paper 52 by viewing and touching pages composed of these different types of paper, and thereby can more correctly understand contents in the instruction manual 40.

Also, the instruction manual 40 provides another explanation such as “Set the setting ‘page paper type’ to ‘plain paper’ for a book composed of paper similar to the plain paper of page 1 to page 10, set the setting ‘page paper type’ to ‘thin paper’ for a book composed of paper similar to the thin paper of page 11 to page 21, and set the setting ‘page paper type’ to ‘thick paper’ for a book composed of paper similar to the thick paper of page 22 and the subsequent pages”, by which proper settings can be made for the page turner 1, and failures in page-turning operations due to the user's self-judgment can be reduced.

Also, a special operation mode may be provided in which the user actually places the instruction manual 40 on the page turner 1, opens a page composed of paper similar to those of desired pages P of the book B, and executes a page-turning operation or photographing operation, so that whether the current settings for the page turner 1 are suitable for the book B can be judged. Here, the settings include the setting of the number of pages to be turned (pause interval), the setting of a paper type (for example, thick paper, plain paper, thin paper, and incompatible paper), the setting of a turning interval (rate), the setting of placement with respect to the page turner, and the designation of an adhesive tape (for example, a tape having strong adhesion, average adhesion, or weak adhesion). In the instruction manual 40, recommended points, and attention points (for example, “thicker paper may not be correctly turned”) are written.

In addition, by a reading operation being actually executed with respect to the plain paper 50 in the instruction manual 40 and the adhesion of the adhesive tape of the sticking section 35 being checked, the life-span of the adhesive tape can be judged with a clear criterion. In this case, by an explanation such as “Open page 1 of the instruction manual and execute a page turning operation (in the test mode). If pages cannot be turned by more than Δ pages, the life-span of the adhesive tape has expired.” being given in the instruction manual 40, the user can correctly recognize the life-span of the adhesive tape.

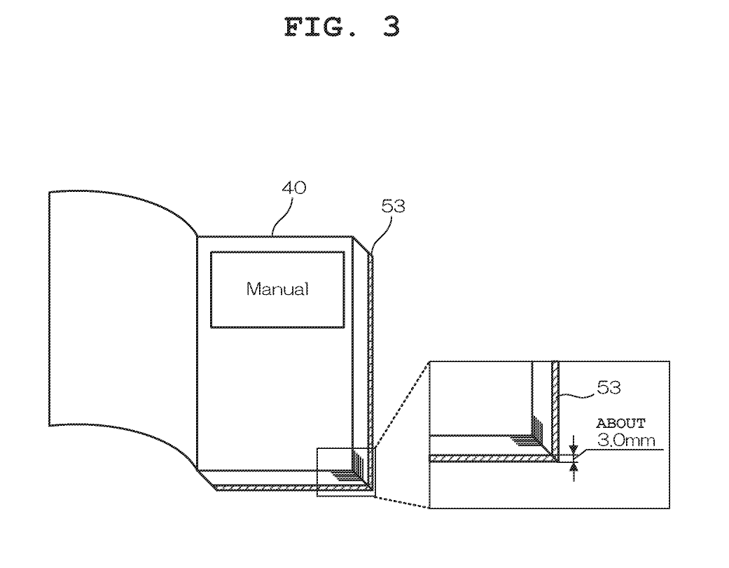

FIG. 3 is a schematic view showing another example of the instruction manual which is provided with the page turner 1 in the embodiment. Here, depending on the thickness of the front cover of the book B, the book B cannot be placed on the page turner 1. In general, users are informed of such a restriction only by it being written in instruction manuals. However, writing it in the instruction manuals is not enough for the users to judge whether the thickness of the front cover of a desired book is a restricted thickness. In the case of the present embodiment, if the user forcibly sets a book having an excessively thick front cover (or back cover), the fixing members for fixing the book on the holding table 6 may be damaged.

Accordingly, in the present embodiment in which the maximum thickness of a front cover that can be turned by the page turner 1 is 3.0 mm or less, pages 53 having a different color are provided such that their total thickness is about 3.0 mm as shown in FIG. 3, or a page serving as a mark (which has a color different from that of the remaining pages) is provided. Then, an instruction such as “Do not use any book with a front cover thicker than that of the portion in XXX color.” or “Open the page in XXX color and do not use any book having a front cover with a height greater than that of the opened page.” is given in the instruction manual 40. As a result, the user can judge whether the front cover of the book B has a thickness that allows the front cover to be turned by the page turner 1, by only placing the book B and the instruction manual 40 side by side without measuring the thickness of the front cover with a ruler or the like. Note that, in addition to the example shown in FIG. 3, a structure where the above-described mark is put on the spine of the instruction manual 40 may be adopted. Alternatively, the example shown in FIG. 3 may be incorporated into the example shown in FIG. 2.

The instruction manual 40 in the examples shown in FIG. 2 and FIG. 3 may be composed of B5 size paper. In this case, the setting position of the page-turning section 3 is required to be changed. By the setting position of the page-turning section 3 being laterally moved in accordance with the size of the book B placed on the holding plate 61, the page-turning section 3 can turn pages P of the book B more accurately. Although this information is written in the instruction manual 40, not many users know the size of a book in hand, as described above.

For this reason, when the instruction manual 40 is composed of B5 size paper that necessitates a change in the setting position of the page-turning section 3, instructions such as “The instruction manual is in B5 size. Make XXX settings for a book smaller than the instruction manual.” and “XXX settings are recommended for a book whose page binding portion is longer than that of the instruction manual 40.” are given in the instruction manual 40, so that the user can make correct settings for the size of the book B with reference to the size of the instruction manual 40 even if the book B has a special size, and the descriptions on the instruction manual 40 can be simplified.

Also, in an inquiry to the cell center or the like, when the user gives an explanation after comparing the book B to the instruction manual 40, telephone communication and loads between the user and the operator can be reduced. For example, in a case where the operator's question is “Is the size of the book in hand larger than B5 size?”, the user can easily explain whether the size of the book B in hand is equal to, smaller than, or larger than B5 size by comparing the book B in hand to the instruction manual 40 (B5 size). Similarly, the user can easily explain whether the pages of the book B in hand are composed of thin paper, plain paper, or thick paper.

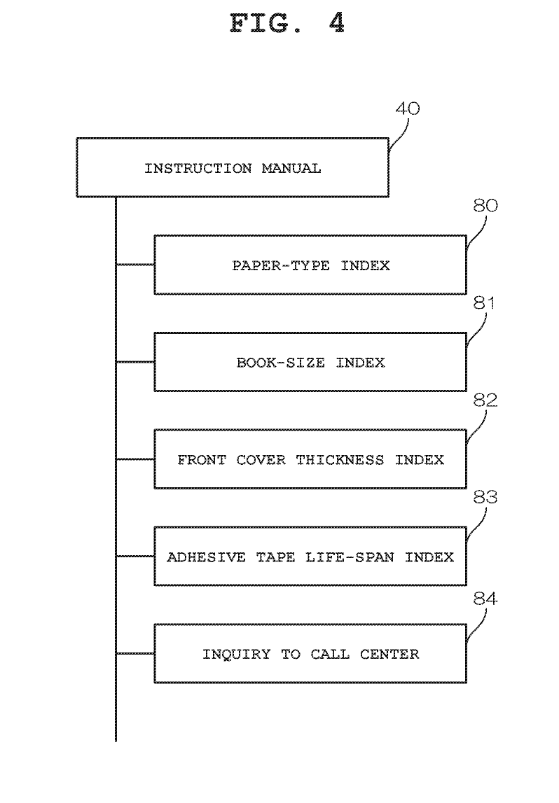

FIG. 4 is a conceptual diagram showing a list of indices that are given by the instruction manual 40 provided together with the page turner 1 in the present embodiment. According to the embodiment, the instruction manual 40, which is provided together with the page turner 1, is composed of different types of paper, and thereby can be used as a paper-type index 80. In addition, by having B5 size that necessitate a change in the setting position of the page-turning section 3, the instruction manual 40 can be used as a book-size index 81 for judging a book size that can be applied to the page turner 1. Moreover, by being structured to have a portion indicating the thickness of a front cover that can be placed on the page turner 1, the instruction manual 40 can serve as a thickness index 82 for judging a front page that can be placed on the page turner 1. Also, by a reading operation being actually performed on a page of the plain paper 50 constituting the instruction manual 40, the instruction manual 40 can serve as a life-span index 83 for the adhesive tape of the sticking section 35. Also, by being incorporated into the instruction manual 40 which is provided together with the page turner 1, the indices 80 to 83 can be used as an inquiry index 84 with respect to the call center.

In the above-described embodiment, these plurality of indices for setting operation conditions for the page turner 1 are incorporated as the page structure of the instruction manual 40. That is, indices that serve as judgment criteria for the use of the page turner 1 can be provided by the instruction manual 40.

Also, in the above-described embodiment, the pages composed of the plain paper 50, the thin paper 51, and the thick paper 52 and bound together are used as pages of the instruction manual 40. As a result, the paper type of a book can be used as an index that serves as a judgment criterion for the use of the page turner 1.

Moreover, in the above-described embodiment, the instruction manual 40 is constituted by a plurality of page groups of different paper types, namely the plain paper 50, the thin paper 51, and the thick paper 52. As a result, by a page-turning operation by the page turner 1 being actually performed using the instruction manual 40, the operation of the page turner 1 can be checked based on the page-turning operation.

Furthermore, in the above-described embodiment, the size of the instruction manual 40, which serves as one of the plurality of indices, is a book size (for example, B5 size) that necessitates a change in the placement of each section of the page turner 1. As a result, correct settings for the size of the book B can be made with reference to the size of the instruction manual 40 even if, for example, the book B has a special size, and the descriptions of the instruction manual 40 can be simplified.

Still further, in the above-described embodiment, a plurality of pages of the instruction manual 40 are colored in a predetermined color as one of the plurality of indices so as to indicate the upper limit (about 3.0 mm) of the thickness of the front cover of a book which can be placed on the page turner 1. As a result, the user can judge whether the thickness of the front cover of a book is an allowable thickness for the use of the page turner 1, by only placing the book and the instruction manual 40 side by side without measuring the thickness of the front cover with a ruler or the like.

Yet still further, in the above-described embodiment, operation conditions for each section of the page turner 1 are presented by a page of the instruction manual 40 being actually turned by the page turner 1 as one of the plurality of indices. That is, by this page turning operation, the operation of the page turner 1 can be checked.

Yet still further, in the above-described embodiment, the adhesion performance of the adhesive tape of the sticking section 35 for turning pages is measured by a page of the instruction manual being actually turned by the page turner. As a result, the life-span of the adhesive tape can be recognized more correctly.

Yet still further, in the above-described embodiment, the instruction manual 40 explains a method of handling the page turner 1 with reference to the features of pages having the plurality of indices. As a result, the user can learn how to handle the page turner 1 by using only the instruction manual 40.

In the above-described embodiment, in the special operation mode, a page-turning operation and a page photographing operation are actually performed using the instruction manual 40. However, the present invention is not limited thereto, and a structure may be adopted in which a mark serving as an “index” is arranged at a predetermined position on a sheet (page) of the instruction manual 40 and, when this mark is detected in an image acquired by photographing, operation control is performed such that this image is not acquired (stored) as electronic book data. As a result of this structure, data that cannot be used as electronic book data are not wastefully saved and do not consume any memory capacity.

Also, in the above-described embodiment, the plain paper 50, the thin paper 51, and the thick paper 52 have been described as the types of paper to be used. However, the paper types are not limited thereto and may include plural types of paper having different surface conditions (textured paper, smooth paper, and the like) which are considered to have affects on the adhesion performance of the sticking section 35.

Moreover, in the above-described embodiment, the indices for paper types (plain paper, thin paper, and thick paper), book sizes, the thicknesses of the front covers of books, the life-span of the adhesive tape, and the setting position of the page-turning section 3 have been exemplarily described. However, the indices are not limited thereto and may include indices for the number of pages to be turned (pause interval), a turning interval (rate), the adhesion level of the adhesive tape (for example, strong adhesion, average adhesion, or weak adhesion), recommended points, and attention points.

While the present invention has been described with reference to the preferred embodiments, it is intended that the invention be not limited by any of the details of the description therein but includes all the embodiments which fall within the scope of the appended claims.

What is claimed is:

1. An instruction manual for an apparatus which turns pages of an opened book, comprising:
a plurality of indices for setting operation conditions for the apparatus as a page structure of the instruction manual.

2. The instruction manual according to claim 1, wherein the plurality of indices are pages acquired by a plurality of different types of paper being bound.

3. The instruction manual according to claim 2, wherein the pages composed of the plurality of different types of paper are constituted by a plurality of page groups of different paper types.

4. The instruction manual according to claim 2, wherein at least one of the plurality of indices is constituted by a page indicating an operation condition for each section of the apparatus which is acquired by a page-turning operation being actually performed on the instruction manual by the apparatus.

5. The instruction manual according to claim 4, wherein the operation condition is an adhesion performance of a sticking section for turning a page.

6. The instruction manual according to claim 1, wherein at least one of the plurality of indices is a size of the instruction manual having a book size which necessitates a change in placement of each section of the apparatus.

7. The instruction manual according to claim 1, wherein at least one of the plurality of indices is a plurality of pages colored in a predetermined color so as to correspond to a thickness of a front cover of the book which is placeable on the apparatus.

8. The instruction manual according to claim 1, wherein a mark serving as an index is arranged at a predetermined position on a page of the instruction manual having the plurality of indices and, when the mark is detected in an image acquired by a page of the book being photographed, the image is not acquired as electronic book data.

9. The instruction manual according to claim 1, wherein explanations regarding a method of handling the apparatus in accordance with pages having the plurality of indices are written.
